(19) United States
(12) Patent Application Publication
(10) Pub. No.: US 2019/0073410 A1
(43) Pub. Date: Mar. 7, 2019

(54) TEXT-BASED NETWORK DATA ANALYSIS AND GRAPH CLUSTERING

(71) Applicant: Estia, Inc., San Antonio, TX (US)

(72) Inventors: Austin Avery Booker, San Antonio, TX (US); Estefan Miguel Ortiz, San Antonio, TX (US); Nakul Jeirath, San Antonio, TX (US)

(21) Appl. No.: 16/111,651

(22) Filed: Aug. 24, 2018

Related U.S. Application Data
(60) Provisional application No. 62/554,182, filed on Sep. 5, 2017.

(51) Int. Cl. G06F 17/30

(52) U.S. Cl. CPC G06F 17/30601; G06F 17/30604; G06F 17/30876

(57) ABSTRACT

Techniques are described for network data analysis and graph clustering analysis to determine clusters of users publishing on networks. Network data, such as items published on social networks or other online networks, is analyzed to determine categories for the published items, and a strength of a correlation between the category and the user who published the item. The category and/or correlation strength are determined based on an analysis (e.g., natural language analysis) of text data included in the published item. Based the various correlations between users and categories, correlations may be determined between pairs of users. A graph may be generated that graphically depicts the various category correlations and/or user correlations as determined based on a set of network data. Clustering is performed to determine cluster(s) of users who are (e.g., strongly) correlated and similar to one another with regard to their category correlations.

### CROSS-REFERENCE TO RELATED APPLICATION

The present disclosure is related to, and claims priority to, U.S. Provisional Patent Application Ser. No. 62/554,182, titled “Text-Based Network Data Analysis And Graph Clustering,” which was filed on Sep. 5, 2017, and the entirety of which is incorporated by reference into the present disclosure.

### BACKGROUND

Traditionally, online marketing or advertising efforts have employed a generally unfocused approach in which information is indiscriminately targeted at a large population of online users. Such efforts may fail to effectively spread the word about a product or brand or fail to reach new audiences, leading to a diminished return on investment in marketing or advertising campaigns. Moreover, the growth of social media and the development of new means for content distribution have created new channels for communication and influence.

### SUMMARY

Implementations of the present disclosure are generally directed to network data analysis to identify clusters of users who publish information to a network. More particularly, implementations of the present disclosure are directed to performing a text-based analysis of network data, such as items published on networks, determining correlations between users and categories of items based on the text-based analysis, and performing a graph analysis based on the correlations to identify user clusters.

In general, implementations of innovative aspects of the subject matter described in this specification can be embodied in methods that include actions of: receiving network data that includes published items that are published on a network by users of the network, the published items each including text data; analyzing the text data included in the published items to determine, for each respective published item: at least one category, and a category correlation strength between the at least one category and a user who published the item; determining for pairs of the users, a user correlation strength between a respective pair of users, wherein the user correlation strength is based on the category correlation strength of between at least one category and each of the respective pair of users; providing a graph that includes: user nodes corresponding to the users, and user edges each indicating a respective user correlation strength; determining at least one cluster of users in the graph, wherein a respective cluster includes a subset of the users that is determined based the user correlation strengths; and communicating cluster data for presentation in a user interface, the cluster data describing the at least one cluster.

These and other implementations can each optionally include one or more of the following innovative aspects: analyzing the text data to determine at least one category for each respective published item further comprises comparing the text data, included in the published item, to a list of terms associated with a category, and determining that the published item is about the category based on a degree of correspondence between the text data and the list of terms; the graph further includes category nodes corresponding to categories, and category edges each indicating a respective category correlation strength; the subset of users for the respective cluster is further determined based on the category correlation strengths; each of the user correlation strengths corresponds to a particular category; the respective cluster corresponds to the category, and is determined based on the user correlation strengths corresponding to the particular category; the network is a social network; the published items are published as one or more of a tweet, a post, a share, or a comment on the social network; the category is included in a hierarchy of categories with different degrees of specificity; the user correlation strength between the respective pair of users is based on a plurality of category correlation strengths between each of a plurality of categories and each of the respective pair of users; and/or the actions further include identifying at least one influencer within the at least one cluster, based on a propagation, within the at least one cluster, of published items published by the at least one influencer.

Other implementations of any of the aspects include corresponding systems, apparatus, and computer programs that are configured to perform the actions of the methods, encoded on computer storage devices.

These and other implementations can provide one or more of the following technical advantages and/or technical improvements over previously used techniques. Traditional techniques for grouping users of a network rely on the explicitly expressed and/or deliberately entered into relationships between users, such as friend relationships, professional connections, relationships between posting user and followers, and so forth. By relying on explicit relationships between users, traditional techniques fail to capture other types of structures or patterns in network data. Implementations determine clusters of users who are similar with respect to their publishing activities, by identifying implicit correlations between the users and the categories of the items published by the users. Thus, implementations identify implicit structures, patterns, and organization within a network that may otherwise go unnoticed by traditional techniques that rely on explicit relationship information. Moreover, by clustering through implicit category identification for published items, implementations provide a more reliable and objective technique for determining groups of users, compared to traditional techniques that rely on users' indications of their friendships, business contacts, and/or other group affiliations. Because implementations provide a more reliable technique for clustering network users, implementations avoid the repeated analyses that traditional techniques are required to perform to recover from errors, false groupings, and/or inaccurate results. Accordingly, implementations avoid the expenditure of computing resources that are consumed by traditional techniques when recovering from errors, such as a processing power, network bandwidth, storage space, active memory, and so forth. In addition to discovering implicit links between users, the implementation described also uncover implicit links between concepts and users. For example, concepts can include an affinity for one or more of the following: a brand, a desired vacation location, a restaurant, an event (e.g., music, festival, social gathering, etc.), a lifestyle choice, and so forth.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system for network data analysis, according to implementations of the present disclosure.

FIG. 2 depicts an example of network data and graph data, according to implementations of the present disclosure.

FIG. 3 depicts an example schematic of a network data graph, according to implementations of the present disclosure.

FIG. 4 depicts an example of cluster data, according to implementations of the present disclosure.

FIG. 5 depicts a flow diagram of an example process for network data analysis, according to implementations of the present disclosure.

FIG. 6 depicts an example computing system, according to implementations of the present disclosure.

### DETAILED DESCRIPTION

Implementations of the present disclosure are directed to systems, devices, methods, and computer-readable media for text-based and/or image-based network data analysis and graph clustering analysis to determine user clusters. Network data, such as items published on social networks or other online networks, is analyzed to determine at least one category for each published item, and a strength of a correlation between the category and the user who published the item. In some implementations, the category and/or correlation strength are determined based on an analysis of one or more images included in the published item. In some implementations, the category and/or correlation strength are determined based on an analysis (e.g., natural language analysis) of text data included in the published item. In some instances, a correlation between a user and a category may be determined based on multiple instances of published items. For example, a user may post multiple items to a social network regarding sports cars, e.g., the posts including images of sports cars and/or text descriptions or mentions of sports cars. Based on the multiple published items, a correlation may be identified between the user and the category of “sports cars,” with a correlation strength that is stronger than would otherwise be determined based on a single published item. Based the various correlations between users and categories, described herein as category correlations, correlations may be determined between pairs of users. Such correlations between users are described herein as user correlations. A network graph may be generated that depicts the various category correlations and connections and/or user correlations as determined based on a set of network data and network algorithms. A clustering algorithm may be applied to determine one or more clusters of users who are connected through user correlations and who are sufficiently similar to one another with regard to their category correlations. The clusters may be provided, as cluster data, to one or more data consumers and/or for presentation in a user interface (UI) of output computing device(s), such as the output device(s) of data consumers.

Implementations determine correlations between users and categories based on the image(s) and/or text data included in the items published by the users. For image-based determination of correlations, computer vision image recognition techniques are employed to determine a correlation based on the similarity (or distance) between the one or more (e.g., or aggregated) images published by a user compared to known image(s) depicting the particular category of the image(s). For text-based determination of correlations, natural language processing, word co-occurrences, sentiment analysis, and/or other language analysis techniques may be employed to determine a correlation of a user with a category that is textually described in the published items of the user. For example, natural language processing is used to extract subject level information, verb information, and/or sentiment information from the text of published items from different users. The extracted information may be analyzed to determine a statistical distance and/or similarity metric between posts of different users. Word usage and/or use of other text (e.g., emoji) is transformed into vector(s), and distance calculations can be performed between different vectors to determine their degree of similarity to one another. Correlations between users may be based on which users are similar to one another based on the features vectors determined from the extracted text data.

The image-based and/or text-based determination of category correlations between users and categories may be employed to determine user correlations between users. A user correlation may be represented as a weighted edge in the graph, where the weight of an edge indicates the correlation strength of a correlation between users. Similarly, a weighted edge that represents a correlation between a user and a category may have a weight that corresponds to the correlation strength between the user and the category. The graph includes user nodes that each represent a user, and category nodes that each represent a category. The graph also includes edges connecting users to categories, the weight of such edges indicating a correlation strength between user and category. The graph also includes edges connecting pairs of users, the weight of such edges indicating a correlation strength between the pairs of users. The graph may describe a network of users and categories that is determined based on shared and/or independent items (e.g., conversations) published online.

The graph may be analyzed using suitable graph clustering algorithm(s) to identify correlations between users that are independent of explicit friendships, acquaintances, or other relationships between users. Accordingly, the implementations described herein may be used to identify clusters of correlated users who are not otherwise connected on the (e.g., social) network(s) through a traditional friend/colleague/acquaintance relationship. Correlations between users may also be described as inferred relationships, e.g., relationships that are not directly stated or shown between users as explicit friendships or other types of explicit social network connections. Such inferred relationships may be determined based on the users publishing similar items regarding categories, such as posts of images and or text data regarding particular categories. For example, two different users may each post images of sports cars and/or text describing sports cars, and the two users may each be correlated with the category of sports cars. Based on their correlation to a same category, the two users may also be correlated with each other in a user correlation. In some implementations, the user correlation between the two users is determined directly based on a similarity between their posted images and/or text data, without first determining separate category correlations between each of the users and the category. Alternatively, category correlations between users and categories may be determined, and the user correlations between users are then determined based on a correlation of each of one or more pairs of users with a same category, or with multiple same categories.

In some implementations, the two users each posting images and/or text data for particular categories may lead to the determination of multiple (e.g., weak) connections between the users, and the presence of multiple (e.g., weak) connections between the users may be used to determine a stronger correlation between the two users. Stated somewhat differently, the correlation between two users may be given more weight if it is based on multiple correlations regarding different categories. For example, if two users each posts image(s) and/or text data regarding both sports cars and Formula 1 racing, then the two users may be correlated/connected more strongly to one another than would be the case if they were connected only through one of the categories.

Traditionally, social networks may be analyzed based on relationships that are explicitly indicated and/or entered into by users, such as a relationship between friends, family members or professional contacts, the relationship of a posting user to follower relationship, and so forth. In previously available systems, such explicit relationships can be used to generate a graph showing interrelationships between pairs of users in a population of users of the social network. Implementations described herein use a graph-based analysis where connections between users are determined implicitly, instead of or in addition to connections that are explicitly established friends, followers, connections, and so forth as in traditional systems. Implicit connections may be determined even in instances where the users are not known to one another, and are not connected in relationships that the users explicitly opt into. Implementations use information that is extracted, from images and/or text of published items, to establish graph edges (e.g., correlations) between pairs of users and/or between users and categories. For example, two different users may not be directly connected as friends, follower(s), business acquaintances, etc., but both are posting nature pictures from a particular location (e.g., San Antonio, USA). The similarity between published items may be used to determine an implicit correlation between the users. This correlation is indicated in the graph as an edge that connects the two users, where the edge shows a (e.g., weak) correlation between the two users based on their similar published items regarding a particular category. Multiple instances of such a (e.g., weak) correlation (e.g., for multiple categories) may be used to infer a stronger correlation between the users.

In some implementations, the graph is rebuilt dynamically based on newly collected network data from one or more networks, as additional similarities and correlations are identified based on analysis of the newly receive image and/or text data in the network data. Thus the network/graph and described implementation can also have a time dependent correlation between identified clusters of users and categories. In some implementations, different categories and/or different specificity of categories may be weighted differently when determining correlations between users and/or between users and categories. For example, a more specific similarity in text data and/or images (e.g., of the Alamo location in San Antonio) may be weighted more heavily than a broader, less specific, and more general similarity (e.g., items regarding Texas history and/or US history more generally). In such examples, the more targeted and specific the subject (e.g., category) of the published items, the greater the weight of the edge indicating a correlation.

The generated graph may be used for a variety of purposes. In some implementations, the graph is analyzed to identify clusters of users in the graph, such as clusters connected by (e.g., weak) correlations between users. The cluster data is then used to direct influencers seeking to influence users on networks to buy products, or engage in other activities. For example, the cluster data may be used to coach influencers to try to break into a different cluster through a connecting user that is in multiple clusters (e.g., make friends with a user in a different cluster), and thus expand the influencer's influence into different clusters of users. Any suitable clustering algorithm may be employed to determined cluster(s) of users in a graph, including K-means clustering, hierarchical clustering, and so forth. Clusters may also be determined based on other information regarding the network users, such as user characteristics (e.g., account status, number of followers, number of postings, etc.). In some instances, clusters may be determined based on explicit connections between users, in addition to the clustering based on implicit connections that are inferred based on different users publishing items regarding the same categories.

The graph may be used for other purposes as well. In some implementations, the graph may be analyzed to identify particular users that are strongly connected to a particular category, such as a particular brand, item, topic, etc. The graph may be analyzed to determine whether such users are influencers of others, influenced by others, and/or to determine whether to engage with the users as possible influencers and/or influenced users. In some instances, a cluster of similar users is identified as a target demographic for targeted advertisements, marketing campaigns, and so forth. In some implementations, a one or more clusters of users may be analyzed to identify influencers within each cluster, such as influencers (e.g., thought leaders) that (positively or negatively) influence other users with respect to categories such as brands, products, topics of conversation, and so forth. Such influencer identification may proceed as described in U.S. patent application Ser. No. 15/355,294, titled “Measuring Influence Propagation Within Networks,” filed on Nov. 18, 2016, which is incorporated by reference into the present disclosure.

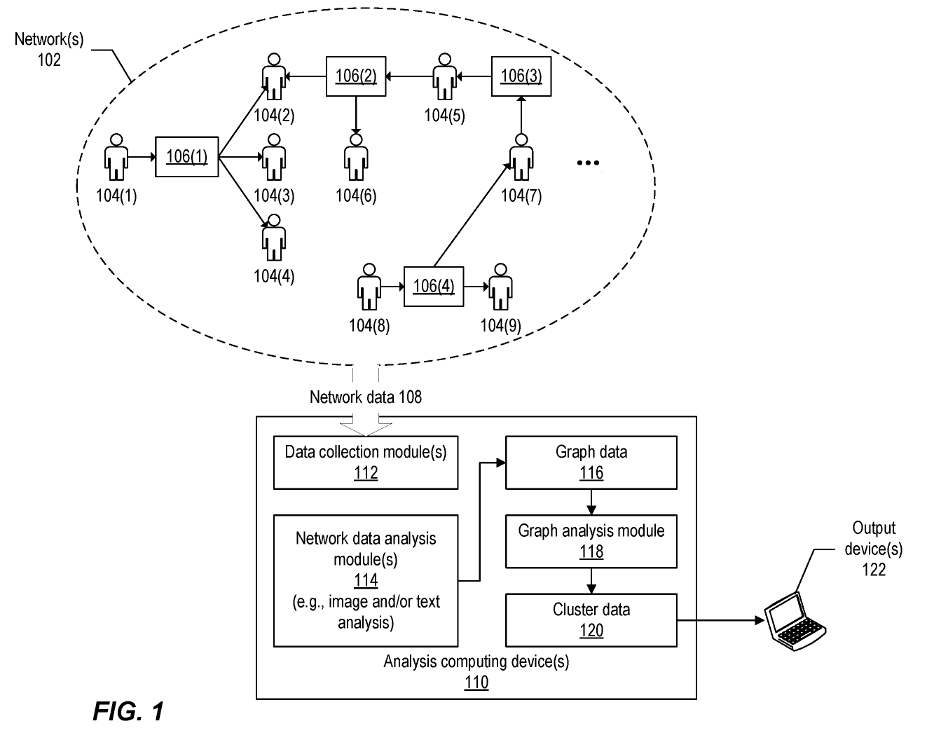

FIG. 1 depicts an example system for network data analysis, according to implementations of the present disclosure. As shown in the example of FIG. 1, the system may include one or more networks 102. A network 102 may include any type of network in which user(s) 104 publish item(s) 106 to be viewed by other user(s) 104. In some instances, the published item(s) 106 may be republished by user(s) 104 any appropriate number of times. Accordingly, a network 102 may be a social network in which users communicate with other users via published items. A network 102 may include users who have registered with the network 102, such that the users have accounts, profiles, or other forms of presence in the network 102. Examples of a network 102 may include Facebook™, Twitter™, Instagram™ Pinterest™, Weibo™, WeChat™, Alibaba™, or others. A network 102 may be public, such that any user may be allowed to publish, view, and republish items. A network 102 may be, to some extent, private, such that a subset of the general public is allowed to publish, view, and republish items.

In the example of FIG. 1, various publishing users 104 have published items 106 that are viewable and/or republishable by other users 104 within the network 102. A network 102 may employ any data format or arrangement of data for published items 106, and published items 106 may be communicated within the network 102 using any communication protocol. A published item may include one or more types of data. For example, a published item may include one or more images, such as still image(s), video data (e.g., streaming video, video files, frames of video, etc.). The image(s) can be arranged according to any suitable image, graphic, and/or video format. A published item may also include text data, including alphanumeric text and/or characters in any appropriate natural language. Text data may also include emoji, symbols, hyperlinks, and/or other text-based data. Published items may also include other types of data, such as graphics, audio data, and so forth.

The system of FIG. 1 also includes one or more analysis computing devices 110, which may include any number of any type of computing device. The analysis computing device(s) 110 may be described as a platform for analyzing network data 108 collected from the network(s) 102. The analysis computing device(s) 110 may execute any number of software module(s), which may be described as an engine for network data analysis.

The analysis computing device(s) 110 may execute one or more data collection module(s) 112 which collect network data 108 regarding one or more network(s) 102. The data collection module(s) 112 may retrieve and store network data 108 that includes one or more published item(s) 106 that are published on the network(s) 102 by users 104. The published item(s) 106 may include metadata describing the published item(s) 106, including but not limited to a timestamp (e.g., date and/or time) of publication, the publishing user 104, a subject line, title, or summary of the item 106 as published, or other metadata such as tags, hashtags, and so forth. The data collection module 112 may also retrieve network data 108 that includes explicit connection information describing explicit connections between users, such as friendship, acquaintance relationships, followers of users, and so forth. The data collection module 112 may also retrieve and store other network data 108 that is available in the network(s) 102, such as demographic information regarding the users 104 of the network(s) 102. Demographic information may include various user characteristics, including but is not limited to one or more of the following: user location (e.g., to any degree of specificity), age, gender, ethnic identification, spoken language(s), profession, hobbies, interests, income level, purchase history, group affiliation(s), education level, or other characteristics.

The network data 108 is accessed and analyzed by one or more network data analysis modules 114 executing on the analysis computing device(s) 110. The analysis module(s) 114 analyze the network data 108 to determine category correlations and user correlations as described herein. Such correlations between user nodes and/or category nodes may be output as graph data 116. A graph analysis module 118 may analyze the graph data 116 to determine one or more clusters of users in the graph data 116, and the cluster(s) may be provided as cluster data 120. The cluster data 120 may be communicated, over one or more networks, to output computing device(s) 122 for presentation in a user interface (UI) executing on the device(s) 122.

In some implementations, the analysis of the network data 108 to determine the graph data 116 and/or cluster data 120 may be performed dynamically with respect to the generation and/or collection of the network data 108. A dynamic process is a process that is performed, in real time, with respect to a triggering event, such as the execution of another process, the presence of data, and/or detection of a particular state of a system. The process may be performed without intentional delay following the triggering event, taking into account any latencies incurred in communicating the data over network(s), accessing memory or storage, and/or performing necessary data processing on computing system(s). In some implementations, there may be no intentional delay between collection and/or generation of the network data 108 and the analysis of the network data 108 to generate the graph data 116 and/or cluster data 120. In some instances, a dynamic process may be performed within a same execution sequence, block, and/or thread as the triggering event, or the dynamic process may be launched or triggered through a process call and/or message that is sent within the same execution sequence, block, and/or thread as the triggering event.

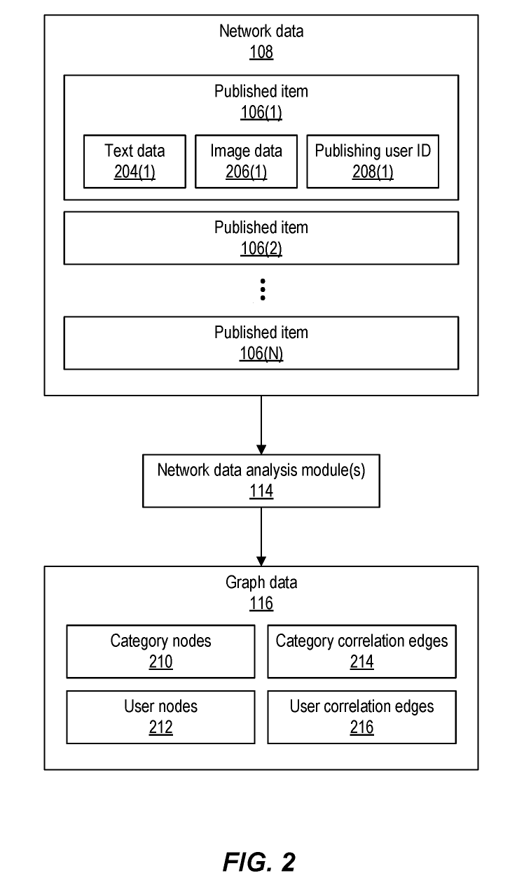

FIG. 2 depicts an example of network data 108 and graph data 116, according to implementations of the present disclosure. The network data 108 may include any number of published items 106. Each published item 106 may include text data 204 and/or image data 206 (e.g., one or more images). The published item 106 may also include metadata such as a publishing user ID 208, a timestamp of when the item 106 was published, identification of the particular network 102 to which the item was published, and so forth.

The published items 106 may be analyzed by the network data analysis module(s) 114 to generate the graph data 116. The graph data 116 includes one or more of the following: category nodes 210, user nodes 212, category correlation edges 214, and/or user correlation edges 216. A category node 210 corresponds to a particular category, such as a product, brand, topic, location, subject, and so forth. A user node 212 corresponds to a particular user 104. A category correlation edge 214 connects a category node 210 to a user node 212, thus indicating a correlation (of some strength) between a particular user 104 and a category. For example, a category correlation edge 214 may be determined between a user node 212 and a category node 210 if the particular user 104 associated with the user node 212 publishes items regarding the particular category associated with the category node 210, such as items that include text data, image data, and/or other information related to the category. A user correlation edge 216 connects two user nodes 212 that are associated with different users 104. The category correlation edges 214 and the user correlation edges 216 may each have a strength value (also described as a weight) that indicates a strength of the particular correlation indicated by the edge.

Implementations support the use of various techniques for determining one or more categories that are associated with a particular published item 106. In some implementations, a text-based analysis may be employed to identify categories associated with items 106. The item 106 may be analyzed, and the various term(s) (e.g., words, phrases, sentences, etc.) present in the item 106 may be compared to a list of terms corresponding to a category, for each of one or more categories, to determine a degree of similarity between the item 106 and the particular category. A term may include any amount of data. For example, a term may be a single word or sequence of characters. A term may also include multiple words, such as a phrase or multi-word term. In some implementations, the data in an item 106 may be preprocessed to determine the terms that are present in the item 106. For example, the item 106 may be parsed based on separator characters such as white space (e.g., spaces, new lines, carriage returns), punctuation characters, or other separators. In some examples, where the item 106 includes audio data, the item 106 may be processed using speech-to-text (STT) conversion method(s) to generate text data based on audio input data, and the text data may be analyzed to determine a category.

In some implementations, image-recognition techniques may be employed to determine the category of an item based on image(s) included in the item. For example, image(s) may be processed using pattern recognition to determine particular element(s) of the image(s), such as automobiles, jewelry, clothing, and so forth. In some instances, the image(s) of the published item are compared to other image(s) that are known to be associated with particular categories, and a similarity (or lack thereof) between the published image(s) and the other image(s) may be used to determine at least one category that corresponds to the image and therefore the published item.

If the calculated degree of similarity between the item and a possible category meets or exceeds a predetermined threshold level of similarity, a determination may be made that the item 106 is about the category, or otherwise associated with the category. If not, the item 106 may not be associated with the category. This may be repeated for a particular item 106 with respect to any number of categories, to determine the one or categories that are associated with the item 106, and the process may be repeated for any number of items 106. A particular item 106 may be associated with any number of categories. In some instances, an item 106 may be associated with a category of “restaurants” as well as a more specific category of “Japanese restaurants” and/or “sushi restaurants.” In some instances, an item 106 may be associated with multiple categories that are not hierarchically related to one another. For example, an item 106 may be associated with a Japanese restaurant as well as a particular brand of beer.

For each published item 106, the analysis may determine one or more categories for the item 106. The analysis may compare words or multi-word terms in the item 106 to a list of terms that are known to relate to a category, such as a library of terms that have been manually or automatically determined for each category. For example, the use of the word “Tiffany” in the published item 106 may lead to a determination that the item 106 is in the categories “jewelry” and “Tiffany brand jewelry.” Further use of the words “engagement” and “ring” in the published item 106 may indicate other categories of “ring” and “engagement ring.” In some examples, the platform determines a probability that the published item 106 corresponds to a category based on a correspondence (e.g., a statistical similarity measure) between terms in the published item 106 and terms known to correspond to the category. In some implementations, the analysis identifies an exact match between terms in the item 106 and terms in the category-specific list to determine similarity. In some implementations, the analysis may employ semantic analysis based on natural language processing or other methods to calculate a similarity based on a semantic closeness between the terms of the item 106 and the category-specific list of terms.

A published item 106 may be designated as being within a category if the calculated similarity exceeds a threshold value. In some implementations, the threshold value may be determined by applying a machine learning method based on statistical analysis. For example, implementations may determine a weighting of multiple items in a particular category based on keyword terms present in the items, and/or associated with image(s) in the items. Use the mean average of the weighting as a threshold or as the basis for the threshold (e.g., threshold=80% of the mean average). In some implementations, a particular published item 106 may be associated with a probability matrix indicating the probabilities that the item 106 corresponds to various categories.

In some implementations, an image-based analysis may be employed to identify categories associated with items 106, in instances where an item 106 includes one or more images. For example, the image(s) in an item 106 may be compared to image(s) that are known to be associated with a particular category (e.g., image(s) of sports cars), and a statistical similarity between the item image(s) and the known image(s) may be calculated. If the statistical similarity is at least a threshold value, a determination may be made that the item 106 is about the category. Metadata regarding the image(s) of an item 106, such as a title of the image(s), filename(s) of the image(s), descriptions of the image(s), other text in the published item, and so forth, may also be used to determine a category.

In some instances, a category may be within a hierarchy of categories that have various degrees of specificity. For example, possible categories may include a broad category of consumer goods as well as progressively more specific categories that are sub-categories of the broad category, such as vehicles, automobiles, sports cars, manual transmission sports cars, convertible sports cars, Porsche™ brand sports cars, 2012 Porsche™ sports cars, and so forth. Categories may include any suitable subject for published items, including but not limited to products, brands, services, topics of discussions, questions for discussion, locations, media titles (e.g., TV shows, films, songs), public figures, celebrities, news topics, current events, and so forth.

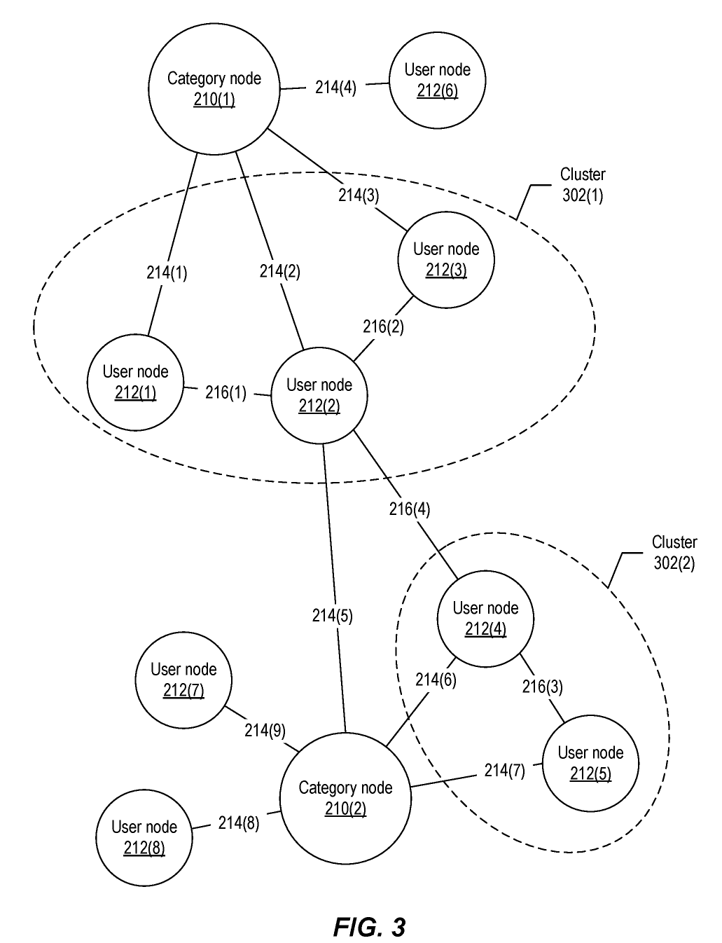

FIG. 3 depicts an example schematic of a graph of network data, according to implementations of the present disclosure. As shown in the example, a particular category node 210 may be connected, via category correlation edge(s) 214, to one or more user nodes 212. A particular user node 212 may be connected, via user correlation edge(s) 216, to one or more other user nodes 212. An interconnected set of user nodes 212 may be designated as a cluster 302. In some implementations, a set of user nodes 212 is designated as a cluster 302 if the user correlation strengths (e.g., the weights of the edges) between each pair of the user nodes 212 in the set is above a pre-determined threshold strength. A particular user node 212 may be a member of any suitable number of clusters 302, or may be a member of no cluster 302.

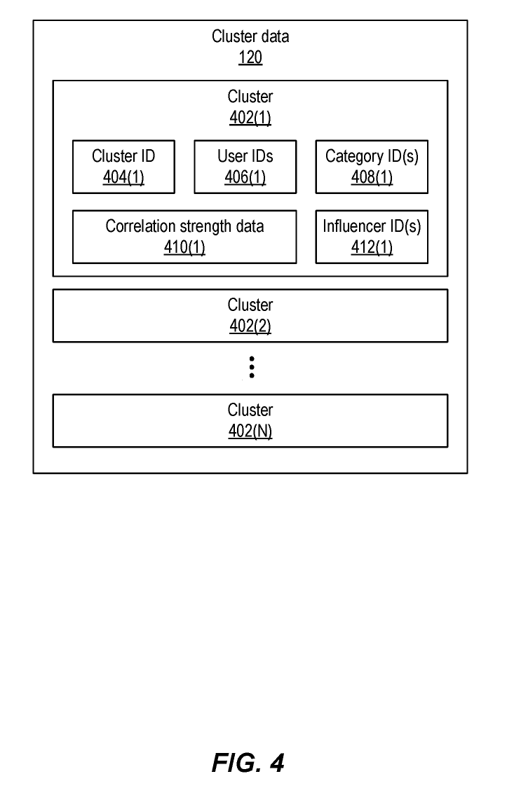

FIG. 4 depicts an example of cluster data 120, according to implementations of the present disclosure. The cluster data 120 may include one or more cluster records 402. Each cluster record 402 may include information regarding the cluster, such as a cluster identifier (ID) 404 that identifies the cluster, the user IDs 406 of the various users 104 for the user nodes in the cluster, and the category ID(s) 408 for the various categories that are associated with the cluster, in instances where a cluster has been determined based on category-specific correlations between users. A cluster record 402 may also include correlation strength data 410, describing the user correlation strengths between the various user nodes in the cluster. In some instances, a cluster of users may be analyzed to identify influencers with the cluster, as described above. In such instances, a cluster record 402 may also include one or more influencer IDs 412 identifying the influencers within the cluster.

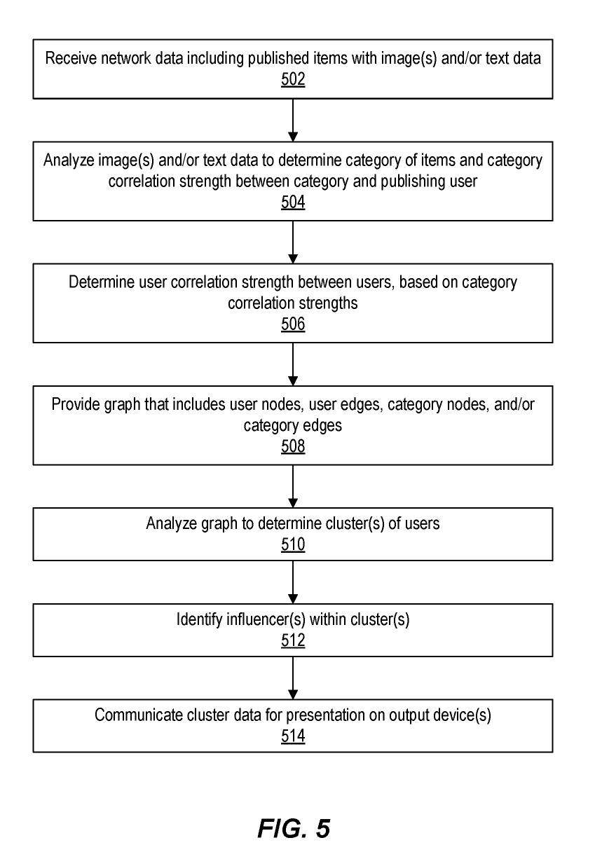

FIG. 5 depicts a flow diagram of an example process for network data analysis, according to implementations of the present disclosure. Operations of the process may be performed by one or more of the data collection module(s) 112, the network data analysis module(s) 114, the graph analysis module 118, and/or other software process(es) executing on the analysis computing device(s) 110 or elsewhere.

The network data 108 is received (502). As described above, the network data 108 may include any number of published items 106 that are published by one or more users 104 on one or more networks 102. The published items 106 may include image(s), text data, and/or other types of content that are publishable over the network(s) 102.

Each of the item(s) 106 may be analyzed (504) to determine one or more categories for the item, as described above. Such analysis may include analyzing the image(s) and/or text data included in each item 106. Based on the analysis, a category correlation strength may be determined. The category correlation strength indicates a degree of correlation between a category of the item(s) and the user who published the item(s).

A user correlation strength is determined between one or more pairs of users, based on the category correlation strengths. For example, if two users each have a category correlation with the same category that is higher than a threshold strength, a user correlation may be determined that connects the two users. The user correlation strength may be based on the individual category correlation strengths of the two users with the category.

A graph is provided (508) that includes user nodes, user edges that connect pairs of user nodes, category nodes, and/or category edges that connect user nodes with category nodes. In some implementations, the weight of an edge indicates a correlation strength for the correlation between the nodes connected by the edge.

The graph is analyzed (510) to determine one or more clusters of users, as described above. In some implementations, one or more influencers are identified (512) in each of the clusters. The cluster data 120, describing the determined cluster(s), is communicated for presentation on the output computing device(s) 122.

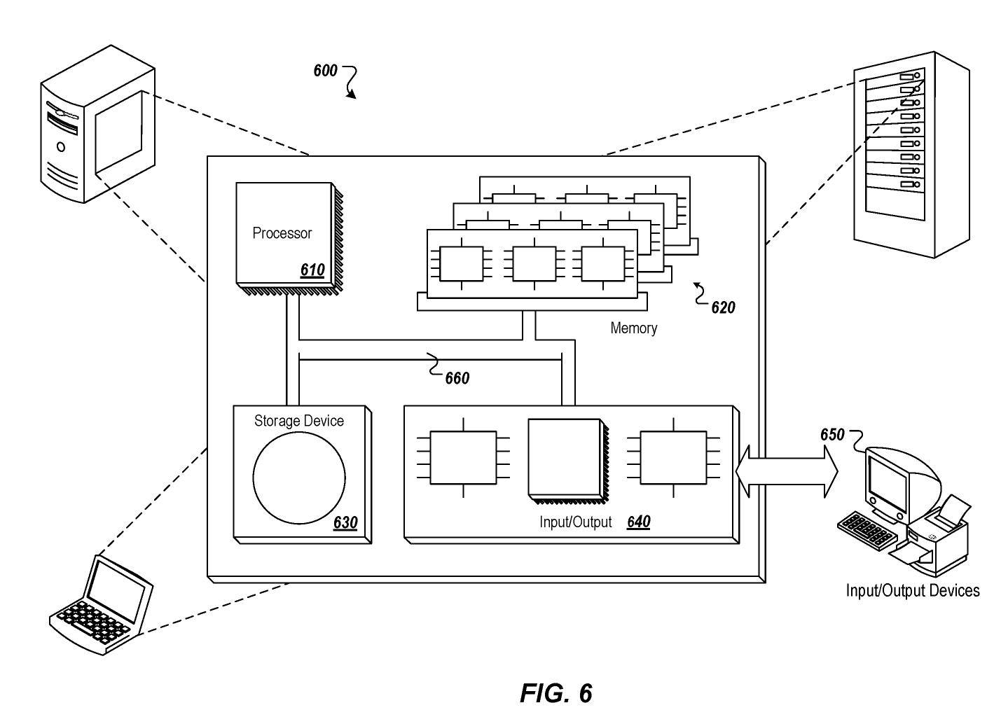

FIG. 6 depicts an example computing system, according to implementations of the present disclosure. The system 600 may be used for any of the operations described with respect to the various implementations discussed herein. For example, the system 600 may be included, at least in part, in the analysis computing device(s) 110, output device(s) 122, computing device(s) operated by one or more of the user(s) 104, and/or other computing device(s) and/or system(s) described herein. The system 600 may include one or more processors 610, a memory 620, one or more storage devices 630, and one or more input/output (I/O) devices 650 controllable via one or more I/O interfaces 640. The various components 610, 620, 630, 640, or 650 may be interconnected via at least one system bus 660, which may enable the transfer of data between the various modules and components of the system 600.

The processor(s) 610 may be configured to process instructions for execution within the system 600. The processor(s) 610 may include single-threaded processor(s), multi-threaded processor(s), or both. The processor(s) 610 may be configured to process instructions stored in the memory 620 or on the storage device(s) 630. For example, the processor(s) 610 may execute instructions for the various software module(s) described herein. The processor(s) 610 may include hardware-based processor(s) each including one or more cores. The processor(s) 610 may include general purpose processor(s), special purpose processor(s), or both.

The memory 620 may store information within the system 600. In some implementations, the memory 620 includes one or more computer-readable media. The memory 620 may include any number of volatile memory units, any number of non-volatile memory units, or both volatile and non-volatile memory units. The memory 620 may include read-only memory, random access memory, or both. In some examples, the memory 620 may be employed as active or physical memory by one or more executing software modules.

The storage device(s) 630 may be configured to provide (e.g., persistent) mass storage for the system 600. In some implementations, the storage device(s) 630 may include one or more computer-readable media. For example, the storage device(s) 630 may include a floppy disk device, a hard disk device, an optical disk device, or a tape device. The storage device(s) 630 may include read-only memory, random access memory, or both. The storage device(s) 630 may include one or more of an internal hard drive, an external hard drive, or a removable drive.

One or both of the memory 620 or the storage device(s) 630 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 600. In some implementations, the CRSM may include a data store that provides storage of computer-readable instructions or other information in a non-transitory format. The CRSM may be incorporated into the system 600 or may be external with respect to the system 600. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 610 and the memory 620 may be supplemented by, or incorporated into, one or more application-specific integrated circuits (ASICs).

The system 600 may include one or more I/O devices 650. The I/O device(s) 650 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 650 may also include one or more output devices such as a display, LED(s), an audio output device (e.g., a speaker), a printer, a haptic output device, and so forth. The I/O device(s) 650 may be physically incorporated in one or more computing devices of the system 600, or may be external with respect to one or more computing devices of the system 600.

The system 600 may include one or more I/O interfaces 640 to enable components or modules of the system 600 to control, interface with, or otherwise communicate with the I/O device(s) 650. The I/O interface(s) 640 may enable information to be transferred in or out of the system 600, or between components of the system 600, through serial communication, parallel communication, or other types of communication. For example, the I/O interface(s) 640 may comply with a version of the RS-232 standard for serial ports, or with a version of the IEEE 1284 standard for parallel ports. As another example, the I/O interface(s) 640 may be configured to provide a connection over Universal Serial Bus (USB) or Ethernet. In some examples, the I/O interface(s) 640 may be configured to provide a serial connection that is compliant with a version of the IEEE 1394 standard.

The I/O interface(s) 640 may also include one or more network interfaces that enable communications between computing devices in the system 600, or between the system 600 and other network-connected computing systems. The network interface(s) may include one or more network interface controllers (NICs) or other types of transceiver devices configured to send and receive communications over one or more communication networks using any network protocol.

Computing devices of the system 600 may communicate with one another, or with other computing devices, using one or more communication networks. Such communication networks may include public networks such as the internet, private networks such as an institutional or personal intranet, or any combination of private and public networks. The communication networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 600 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method performed by at least one processor, the method comprising:
receiving, by the at least one processor, network data that includes published items that are published on a network by users of the network, the published items each including text data;
analyzing, by the at least one processor, the text data included in the published items to determine, for each respective published item: at least one category, and a category correlation strength between the at least one category and a user who published the item;
determining, by the at least one processor, for pairs of the users, a user correlation strength between a respective pair of users, wherein the user correlation strength is based on the category correlation strength of between at least one category and each of the respective pair of users;
providing, by the at least one processor, a graph that includes: user nodes corresponding to the users, and user edges each indicating a respective user correlation strength;
determining, by the at least one processor, at least one cluster of users in the graph, wherein a respective cluster includes a subset of the users that is determined based the user correlation strengths; and
communicating, by the at least one processor, cluster data for presentation in a user interface, the cluster data describing the at least one cluster.

2. The method of claim 1, wherein analyzing the text data to determine at least one category for each respective published item further comprises:
comparing the text data, included in the published item, to a list of terms associated with a category; and
determining that the published item is about the category based on a degree of correspondence between the text data and the list of terms.

3. The method of claim 1, wherein the graph further includes: category nodes corresponding to categories, and category edges each indicating a respective category correlation strength.

4. The method of claim 3, wherein the subset of users for the respective cluster is further determined based on the category correlation strengths.

5. The method of claim 1, wherein:
each of the user correlation strengths corresponds to a particular category; and
the respective cluster corresponds to the category, and is determined based on the user correlation strengths corresponding to the particular category.

6. The method of claim 1, wherein:
the network is a social network; and
the published items are published as one or more of a tweet, a post, a share, or a comment on the social network.

7. The method of claim 1, wherein the category is included in a hierarchy of categories with different degrees of specificity.

8. The method of claim 1, wherein the user correlation strength between the respective pair of users is based on a plurality of category correlation strengths between each of a plurality of categories and each of the respective pair of users.

9. The method of claim 1, further comprising:
identifying, by the at least one processor, at least one influencer within the at least one cluster, based on a propagation, within the at least one cluster, of published items published by the at least one influencer.

10. A system, comprising:
at least one processor; and
a memory communicatively coupled to the at least one processor, the memory storing instructions which, when executed by the at least one processor, cause the at least one processor to perform operations comprising:
receiving network data that includes published items that are published on a network by users of the network, the published items each including text data;
analyzing the text data included in the published items to determine, for each respective published item: at least one category, and a category correlation strength between the at least one category and a user who published the item;
determining for pairs of the users, a user correlation strength between a respective pair of users, wherein the user correlation strength is based on the category correlation strength of between at least one category and each of the respective pair of users;
providing a graph that includes: user nodes corresponding to the users, and user edges each indicating a respective user correlation strength;
determining at least one cluster of users in the graph, wherein a respective cluster includes a subset of the users that is determined based the user correlation strengths; and
communicating cluster data for presentation in a user interface, the cluster data describing the at least one cluster.

11. The system of claim 10, wherein analyzing the text data to determine at least one category for each respective published item further comprises:
comparing the text data, included in the published item, to a list of terms associated with a category; and
determining that the published item is about the category based on a degree of correspondence between the text data and the list of terms.

12. The system of claim 10, wherein the graph further includes: category nodes corresponding to categories, and category edges each indicating a respective category correlation strength.

13. The system of claim 12, wherein the subset of users for the respective cluster is further determined based on the category correlation strengths.

14. The system of claim 10, wherein:
each of the user correlation strengths corresponds to a particular category; and
the respective cluster corresponds to the category, and is determined based on the user correlation strengths corresponding to the particular category.

15. The system of claim 10, wherein:
the network is a social network; and
the published items are published as one or more of a tweet, a post, a share, or a comment on the social network.

16. The system of claim 10, wherein the category is included in a hierarchy of categories with different degrees of specificity.

17. The system of claim 10, wherein the user correlation strength between the respective pair of users is based on a plurality of category correlation strengths between each of a plurality of categories and each of the respective pair of users.

18. The system of claim 10, the operations further comprising:
identifying at least one influencer within the at least one cluster, based on a propagation, within the at least one cluster, of published items published by the at least one influencer.

19. One or more computer-readable media storing instructions which, when executed by at least one processor, cause the at least one processor to perform operations comprising:
receiving network data that includes published items that are published on a network by users of the network, the published items each including text data;
analyzing the text data included in the published items to determine, for each respective published item: at least one category, and a category correlation strength between the at least one category and a user who published the item;
determining for pairs of the users, a user correlation strength between a respective pair of users, wherein the user correlation strength is based on the category correlation strength of between at least one category and each of the respective pair of users;
providing a graph that includes: user nodes corresponding to the users, and user edges each indicating a respective user correlation strength;
determining at least one cluster of users in the graph, wherein a respective cluster includes a subset of the users that is determined based the user correlation strengths; and
communicating cluster data for presentation in a user interface, the cluster data describing the at least one cluster.

20. The one or more computer-readable media of claim 19, wherein:
the network is a social network; and
the published items are published as one or more of a tweet, a post, a share, or a comment on the social network.
